(19) United States
(12) Patent Application Publication
(10) Pub. No.: US 2015/0296484 A1
(43) Pub. Date: Oct. 15, 2015

(54) MANAGING RESOURCE LICENSES

(71) Applicants: Jan-Erik Ekberg, Vantaa (FI); Mikko Aleksi Uusitalo, Helsiniki (FI); Jari-Jukka Harald Kaaja, Jarvenpaa (FI)

(72) Inventors: Jan-Erik Ekberg, Vantaa (FI); Mikko Aleksi Uusitalo, Helsiniki (FI); Jari-Jukka Harald Kaaja, Jarvenpaa (FI)

(73) Assignee: Nokia Corporation, Espoo (FI)

(21) Appl. No.: 14/123,933

(22) PCT Filed: Jun. 14, 2011
(86) PCT No.: PCT/FI2011/050560

§ 371 Date: Feb. 22, 2014

(51) Int. Cl. H04W 72/00; H04W 12/06; H04W 4/02; H04W 64/00; H04W 4/00

(52) U.S. Cl. CPC H04W 72/005; H04W 64/003; H04W 4/008; H04W 4/025; H04W 12/06

(57) ABSTRACT

There is provided a solution in which a license for specific radio resources assigned to a terminal device is obtained, wherein the license is valid at a predetermined location context for a predetermined time duration; and at least one surrounding terminal device in the location context is caused to be informed about the license in order to allow the at least one surrounding terminal device to release the specific radio resources according to the license.

### FIELD

The invention relates generally to communication networks. More particularly, the invention relates to resource management in the communication networks.

### BACKGROUND

Cognitive radio network and other “loosely” connected network structures may provide a terminal with communication capabilities where the terminal may change communication parameters according to available or existing radio resources in the surrounding communication environment. This may be advantageous as it may lead to an increased quality of service (QoS) and to more efficient resource usage. An exemplary communication parameter that may be adapted is the bandwidth or frequency of the data stream. In order to apply a certain bandwidth without causing or suffering from interference, the terminal may need an allocation or a license for such bandwidth. In other words, efficient and reliable radio resource management is needed.

### BRIEF DESCRIPTION OF THE INVENTION

Embodiments of the invention seek to improve radio resource management in communication networks.

According to an aspect of the invention, there are provided methods as specified in claims 1, 9 and 12.

According to an aspect of the invention, there are provided apparatuses as specified in claims 15, 23, 26 and 29.

According to an aspect of the invention, there is provided a computer program product as specified in claim 30.

According to an aspect of the invention, there is provided an apparatus comprising means for performing any of the embodiments as described in the appended claims.

Some example embodiments of the invention are defined in the dependent claims.

### LIST OF DRAWINGS

In the following, the invention will be described in greater detail with reference to the embodiments and the accompanying drawings, in which

FIG. 1 presents a communication network according to one embodiment;

FIG. 2 shows a bandwidth allocation for different users according to one embodiment;

FIG. 3 shows broadcasting of data to multiple users according to one embodiment;

FIG. 4 illustrates a cognitive radio device moving across multiple location contexts according to one embodiment;

FIGS. 5 and 6 present flow diagrams according to some example embodiments;

FIGS. 7 and 10 depict apparatuses according to some embodiments; and

FIGS. 8, 9 and 11 illustrate flow diagrams according to some example embodiments.

### DESCRIPTION OF EMBODIMENTS

The following embodiments are examples. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller. a Node B, or an evolved Node B, for example), at least one user equipment (UE) (also called a user terminal, terminal device or a mobile station, for example) and optional network elements that provide the interconnection towards the core network. The base station may connect the UEs via the so-called radio interface to the network. In addition the UEs may also apply so called peer-to-peer communication, where one UE directly communicates with another UE. The base station may provide radio coverage to a cell, control radio resource allocation, perform data and control signaling, etc. The cell may be a macrocell, a microcell, or any other type of cell where radio coverage is present.

Typically radio communication parameters, such as the bandwidth and frequency, are predetermined for the user equipment (UE), such as a user terminal, a palm computer, a laptop, a tabloid computer, a cellular phone, a communicator, a smart phone, or any other communication apparatus capable of operating in the communication network. However, in future cognitive radio networks, the radio devices, such as the UEs, may sense their environment, including the spectrum use and the presence of other such radio devices. As a result they may be able to optimize the interference avoidance. Such radio devices may be called cognitive radios (CR) or cognitive radio devices. User equipment may comprise such cognitive radio functionalities. In the cognitive radio network, the UE may connect to spectrum through a dynamic access, e.g. operate under varying licensing conditions and is not continuously authorized to access the spectrum. The UE may thus be provided with a possibility to adapt the communication parameters according to current needs, such as time, place, surrounding situation and application used. Moreover, the resource allocation for the required new communication parameters, such as bandwidth, is advantageously done independently of the radio access technology (RAT). In some cases it may be advantageous to perform such allocation without the presence of a bandwidth broker or equivalent. The bandwidth broker typically is an entity that is responsible for admission control, resource allocation and other policy decisions.

In cognitive radio networks, whether the communication parameters may be changed or not may be based on active monitoring of several factors in the surrounding radio communication environment. One very common factor is the radio frequency spectrum usage in the area. For the radio spectrum, licensed bands and unlicensed bands are defined. The licensed bands denote to frequency spectrum that has already been licensed for certain use, whereas the unlicensed bands comprise frequencies that are basically available for everybody, such as the unlicensed national information infrastructure (U-NII) band or the industrial, scientific and medical (ISM) band. In a spectrum sensing cognitive radio, the terminal device may use the spectrum in a dynamic manner. This allows the terminals to apply a frequency band that suits their needs in an optimal manner.

The terminal applying the modified parameters according to the cognitive radio principle may require a license or a right for the usage of the modified parameters. The typical use of the license is that the execution of the right needs to be enforced while the target of the license, such as the bandwidth, is already being consumed or used. The enforcement may be made at network nodes (e.g. routers). A kind of a similar approach is used for example in the differentiated services-approach (DiffServ), where packets are labeled with QoS parameters, and prioritized accordingly. However, the QoS parameters are not licensed in the sense that their origin may not cryptographically validated.

The centralized enforcement by the network nodes (e.g. routers) may not be optimal. Consequently, in one embodiment the enforcement is made in a collaborative manner by the entities that use the license, e.g. by the entities that behave in accordance to a policy specified by the license issuer. Such an entity may be the UE or any cognitive radio device, for example. This may allow enforcement even in the absence of centrally coordinated cognitive radio network. Accordingly, if licensing is needed, the license enforcement shall also be implemented and enforced in a collaborative manner, possibly using trusted execution environments (TEEs) in the regulated cognitive radio devices. Algorithms for exchanging license information between UEs and thus enabling the collaborative enforcement may be efficient so that interference is minimized and quality of service is optimized.

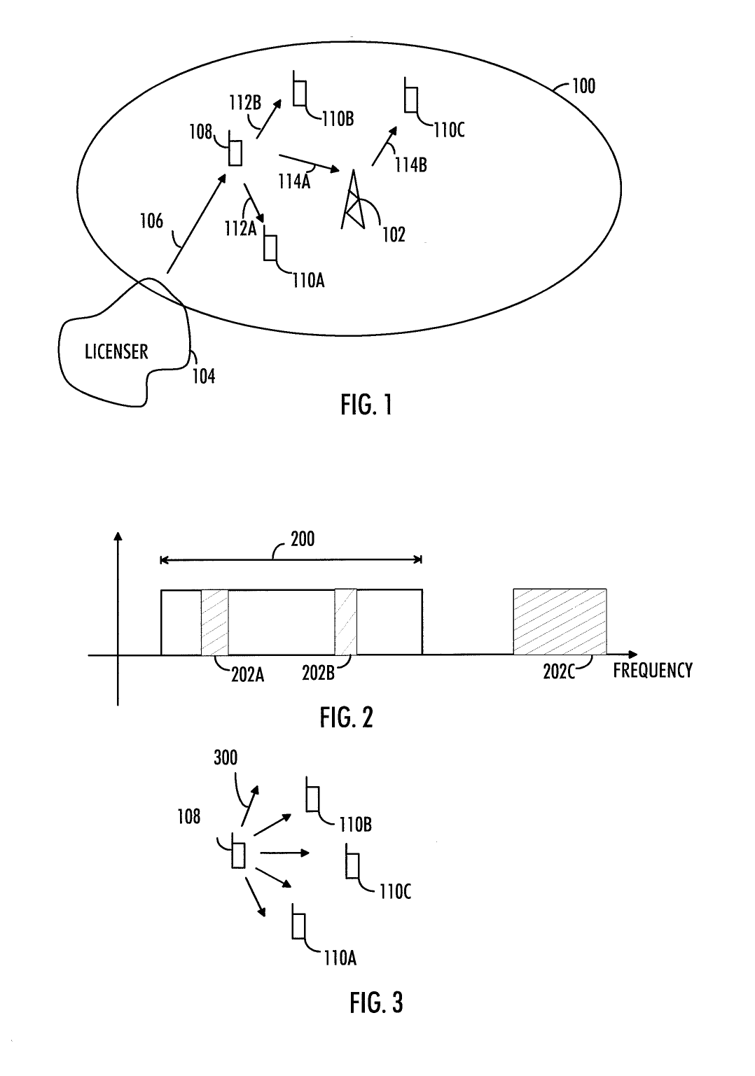

Therefore, in one example embodiment the terminal (e.g. the UE 108 in FIG. 1) obtains a license for specific radio resources assigned to the UE 108. The UE 108 may cause at least one surrounding terminal device 110A, 110B and 110C in the location context to be informed about the license. This may be done in order to allow the at least one surrounding terminal device 110A to 110C to release the specific radio resources according to the license. In other words, the UEs 108 and 110A to 110C in the location context enforce the license cooperatively. Such collaborative enforcement may take place by regulating that whenever a radio device 108 presents/broadcasts a license for a resource, such as for bandwidth, at least one radio device 110A to 110C in the location context will confirm to the license by “backing off” from the radio resources according to the license. In other words, at least one of the surrounding UEs 110A to 110C allow the license contents in terms of resources to be fulfilled by the UE 108 to which the license is assigned to. It may be that all of the surrounding UEs 110A to 110C confirm to the license and back-off from the radio resources. However, it may be that not all of the UEs 110A to 110C are able to back-off, in which case one or more of the UEs 110A to 110C back-off. The at least one terminal device 110A to 110C may unconditionally release the specific radio resources according to the license. For example, the at least one UE 110A to 110C who releases the resources may do so without any reservations or further verifications.

The license may be obtained via a wireless or wired communication link 106 from a licenser entity 104. The licenser, a trusted entity 104, may be a bandwidth broker, for example, or any other network node that is responsible for allocating radio resources to any of the terminal devices 108 and 110A to 110C. The license may be a valid license. The license may be valid at a predetermined location context for predetermined time duration. Additionally, the license may be valid for a predetermined content set as well, if such further restrictions are applied. Then, it is tied at least to time and physical location. The physical location may be, for example, a cell 100 in FIG. 1. A valid license means that it is a trusted license. Such a trusted license may be a cryptographically signed license, wherein the signature is from the trusted entity 104 (e.g. a trust root), for example. Alternatively or in addition to, the license file obtained by the surrounding devices 110A to 110C may be structured, e.g. as a digital certificate or an attribute certificate in coherence with a well-known standard. The valid license may be tied to the device 108 identity, to time period, to a location context 100 and/or to the trusted entity 104, for example.

The location context may denote the geographical location where the UE resides, the cell 100 where the UE resides, the carrier frequency applied by the UE, and/or the radio technology applied by the UE, for example. Thus, the license may be valid only in the physical location, such as in the cell 100, where the terminal device 108 resides. In another embodiment, the license may be valid for only certain frequency. In this case, only those surrounding UEs, which use the same frequency, may be informed or may enforce the license. In one embodiment, the license is RAT-specific. However, it is also possible that all the CRs, regardless of the radio technology, for example, need to enforce the license without limiting to only certain UEs applying the specific RAT. In this case also terminal devices in ad-hoc and peer-to-peer networks are informed of the license so that they can back-off as well. The license may be informed by applying user data communication, thus control signaling may not be required and the radio networks to which the UEs 108, 110A to 110B belong to may be irrelevant. Naturally, any combination of the above location context attributes is possible.

For such co-operative enforcement and radio resource management to be possible, the UEs in the location context may be context aware. This may be possible by the UEs 108 and 110A to 110C monitoring the channel they are using and may thus participate in the resource allocation in the location context, such as in the cell 100. As devices are aware of their location context, a new device entering the context may present to other devices a bandwidth license, as well as possibly some real-time (interactive) cryptographic proof of its identity. All other cognitive radio devices 110A to 110C may then validate the distributed license, and if it is valid, they may unconditionally release the right amount of channel allocation for the device 108 (in accordance with the valid license). Thus, in one embodiment, the UEs 110A to 110C will check the validity of the distributed license information. After verifying the validity of the license, the UEs 110A to 110C may release the resources. The property of unconditional release of resources may exist in all devices approved for CR operation, even in such devices that never reserve bandwidth for themselves. The proposed authorized spectrum access may ensure low interference and optimal efficiency of the radio resource usage, for example.

In one embodiment, the terminal device 108 having the license may inform other surrounding CRs 110A to 110B in the location context via direct peer-to-peer communication channels 112A and 112B. The CRs 110A and 110B may be configured to listen to the predetermined channels 112A and 112B, respectively. Alternatively or in addition to, the UE 108 may inform the surrounding UE 110C via communication links 114A and 114B. In other words, the informing may take place by communicating the information of the license via the link 114A to an evolved node B (eNB) or base station 102 (or any radio network entity capable of routing information) and the eNB 102 may then (possibly process and) forward the data to the UE 110C via the link 114B. Thus, the informing may be aided by the network entity 102 as the informing takes place via the network node 102. This may be advantageous if all or some of the surrounding CRs are not capable of direct peer-to-peer communication but require centralized approach, or if the propagation loss between the UE 108 and the UE 110C is so severe that direct data communication would not work, for example. In this way, the surrounding UEs may perform an admission control for the UE 108 by participating in a distributed resource management system run in at least one of the surrounding CR devices.

FIG. 2 shows an example of possible bandwidth allocations for different UEs. Let us assume that the terminal 108 has been allocated a wide bandwidth 200. Let us also assume that the UEs 110A to 110C have reserved or have been allocated bandwidths 202A, 202B and 202C, respectively. As the UEs 110A to 110C have been informed about the valid license granted to the UE 108, the other nodes 110A to 110C may unconditionally back-off from the bandwidth 200 of the license. In practice, this means that the UEs 110A and 110B will not use their allocated or reserved bandwidths 202A and 202B but will either wait until the license is expired in respect of time or place, for example, or try to get an allocation of different bandwidth not overlapping with the bandwidth 200 according to the valid license. The UE 110C need not back-off from its allocated/reserved bandwidth 202C as the bandwidth 202C is not overlapping with the bandwidth 200 of the valid license. As a result, the UE 108 may be able to perform data communication with minimum interference by using the reserved bandwidth 200, for example.

Even though FIG. 1 shows the license being assigned to one CR 108, in one embodiment, the licenses may also be assigned to groups of CRs having certain identifiers (Ids). For example, the UE 108 may obtain the license for specific radio resources, wherein the license is assigned to a group of at least two terminal devices. Such situation may arise, for example, when a company license is to be assigned. When such situation is present, the surrounding UEs 110A to 110C may receive the information of the license from multiple CRs who have been assigned the company license. In this case, the devices 110A to 110C that back-off from the license bandwidth need to respect only the first valid statement related to this license.

In one embodiment, the UE 108 may inform a representative of the centralized control, such as the eNB, the base station, or any other network entity representing the centralized control, about the license. In this way, the eNB need not do a check from a central database.

In one embodiment, the license may include special features, possibly managed by the frequency broker 104 (also known as a license broker or a bandwidth broker). In this case, the license broker 104 may have a local interface, such as a near field communication (NFC) interface. The license broker 104 may thus assign the license via the local interface by applying a point-to-point communication interface, such as a Bluetooth interface, the NFC interface, etc. The local interface may be used e.g. to provision licenses that have special features, which allow the licenses to work as coupons. For example, these special features allow the license to have serial features, periodic or conditional features. As examples, these features may comprise at least one of the following: “buy 10 licenses, get one for free”-approach, a periodic license that is valid only at certain times, and/or free CR “internet” for certain period of time when you take your coffee in our coffee shop. Thus, in one embodiment, at least one attribute is added to the license, wherein the at least one attribute sets at least one serial, periodic and/or conditional feature to the license. This may allow for more flexibility for the actions of the bandwidth broker 104.

In one embodiment, at least one of the at least one surrounding UEs 110A to 110C in the location contexts, such as in the cell or other geographically limited area, are informed directly about the license via a dedicated broadcast channel. For example, a broadcast channel in a peer-to-peer fashion at a given physical location may be used to cause the surrounding UEs to be informed about the license. This is shown in FIG. 3, where the UE 108 broadcasts the information about the license to UEs 110A to 110C via the dedicated broadcast channel 300. As a result, the UEs 110A to 110C obtain the information about the (valid) license via the dedicated broadcast channel 300. The broadcast channel is dedicated for this purpose and the surrounding UEs 110A to 110C know to listen to the broadcast channel. The broadcast may be performed with such a transmit power which ensures that the broadcast is not received by UEs in another location contexts. The broadcasted data may alternatively or in addition to comprise information that allows the UE that received the data to know whether it needs to respect the valid license. For example, the data may contain information of the location contexts, such as the cell 100, and the UEs outside the cell 100 then know that, even if they receive the valid license, they do not need to respect it.

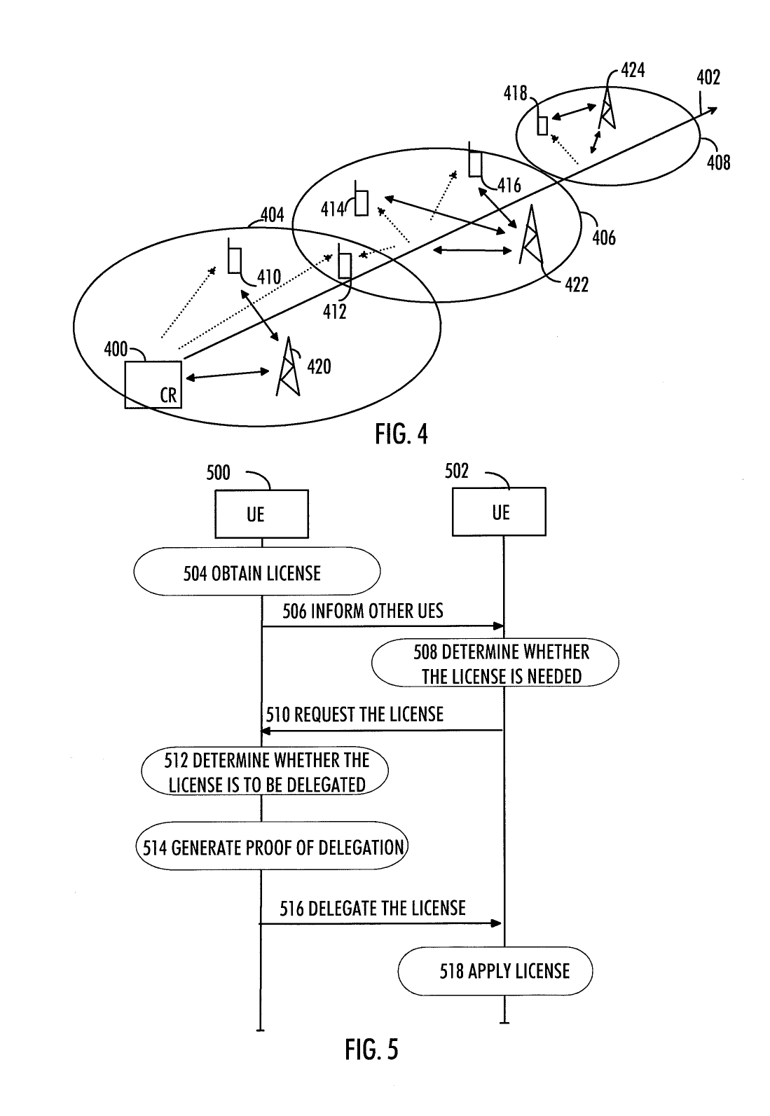

In one embodiment, as shown in FIG. 4, the cognitive radio device 400, such as the UE 108 in FIG. 1, estimates location contexts the terminal device 400 traverses in the future. Such estimation may be based on a trajectory vector (e.g. when in a car on a road), history (e.g. regular movements during a typical workday) or explicit user input. Such trajectory is shown by a solid line 402 in FIG. 4. According to the estimation, the location contexts the device 400 is going to traverse or locate in the near future comprises, for example, cells 404, 406 and 408. As part of the location contexts, the estimation may also indicate what is the radio access technology in each of the cells 404 to 408, what is the frequency applied in each of the cells 404 to 408, what is the time spent in each of the cells 404 to 408, etc. Based on the estimated future location contexts, the UE 400 may acquire location context-specific licenses for the future location contexts. In addition, the UE 400 may acquire location trajectory vector specific licenses. The acquiring may comprise requesting or reserving the radio resources for each or some of the location contexts beforehand from the entity responsible of allocating such licenses, such as the bandwidth broker 104 of FIG. 1, for example.

After receiving the license for the specific location context (either all licenses at once, or one by one before arriving to a new location context), the CR device 400 may inform those surrounding cognitive radio devices 410, 412, 414, 416 and 418 that are present in the location context where the CR device 400 is currently locating. The information takes place, as shown with dotted arrows in FIG. 4, via peer-to-peer direct connections (multicasting), via respective central nodes 420, 422, and 424 and/or via the dedicated broadcast channel. The solid arrows show that the cognitive radio devices 400 and 410 to 418 may communicate with the central nodes 420 to 424 in the respective cells 404 to 408. The communication between the CR device 400 and any of the central nodes 420 to 424 may take place by applying the radio resources according to the valid license corresponding to a given location context. This is enabled as the surrounding UEs 410 to 418 have back-off from using the (overlapping) resources. It should be noted that the radio resources, such as the bandwidth, to be used according to the valid license may vary between the location contexts as the valid license may be different in different location contexts. It all depends on the resource usage in the location contexts. On the contrary, the devices 410 to 418 may only apply such radio resources that are not comprised in the radio resources of the valid license in the location context.

Additionally, In case a device has no valid license, it may request from the valid license holder to one time use (under the control of the valid license holder) or utilize a common pool of licenses (if such exists, without any resource guarantee). Alternatively, a non-valid license owner may need to have connection to a CR license brokers before getting the valid license and before starting to operate normally.

Looking again FIG. 1, according to one embodiment, at least one of the at least one surrounding terminal device 110A to 110C is caused to be informed about the proof of identity of the terminal device 108 to which the license has been assigned to, wherein the proof of identity is valid over the pre-determined time duration. Thus, the at least one surrounding device 110A to 110C obtains proof of identity of the at least one terminal device 108 to which the license is assigned to. It should be noted that, as previously said, the license may be assigned to a plurality of devices, not only to one device. As said, the proof of identity of the device entering the location context or transmitting valid license information may be based on time because the license as well is in many cases time dependent. The proof may be a digital signature by the license holder, wherein the signature is valid for predetermined time duration. The signature may be broadcasted with the other license related information, such as the certificate of the license. In addition or alternatively, there may also exist a location context-specific beacon, such as a random beacon agreed among the devices 108 and 110A to 110C present, which beacon is used to challenge the device 108 to authenticate its identity. Thus, the UE entering the location contexts or transmitting the license information may also transmit the beacon to the other UEs because the beacon serves as evidence of the authentication of the device.

FIG. 5 shows a flow diagram of an example method for delegating a license to another terminal device. In this example flow diagram it is assumed that a UE 500 obtains a license for specific radio resources in step 504. As proposed, it informs the other surrounding UEs, including UE 502, in the location context in step 506. After receiving the information on the assigned license, the UE 502 determines in step 508 whether the UE 502 itself needs the assigned license. The determination result may depend on the current needs of the UE 502 in relation to currently assigned resources, data traffic, buffer status, etc. For example, if the UE 502 has a lot of urgent traffic in the buffer, it may decide that it actually needs the license for its own use. After having decided that the license is in fact needed by the UE 502, the UE 502 may, in step 510, request the license for its own use from the current license holder, the UE 500, to which the (valid) license has been assigned to. As a result of the request, the UE 500 may in step 512 determine whether or not the license may be delegated to the other terminal device 502. The determination result may depend on the current needs of the UE 500 in relation to the data traffic, buffer status, location context, etc. If it decides that the delegation of the license is possible and to be done, the UE 500 may generate a proof of delegation in step 514. The proof of delegation may be a signature, for example. The proof may indicate that the original owner of the license delegated the license to another known ID (the UE 502), who can use the license along with this additional proof. In step 516, the UE 500 may delegate the license to at least one other terminal device 502 in order to allow the at least one other terminal device 502 to utilize the radio resources according to the license, wherein the delegation is accompanied with a proof that the terminal device has delegated the license.

This way the requester (UE 502) obtains the license from the at least one terminal device 500 in order for the requester 502 to utilize the radio resources according to the license, wherein the obtained license is accompanied with a proof that the at least one terminal device 500 to which the license has been assigned to has delegated the license to the requester 502. In step 518, the requester (e.g. the UE 502) may apply the license when performing communication with the central node, for example.

The enforcement by the other surrounding cognitive radio devices may have been done already when the UE 500 informed others about the license. Alternatively, the UE 502 may inform other nodes in the location context of the UE 502, which may be different than the location context of the terminal 500. Such difference in the location contexts may take place when the UE 502 is in a different physical location than the UE 500. The UE 500 may locate within a cell #1 and the UE 502 may locate in the edge of the cell #1 which location may also be within a cell #2, for example. In this case, the information sent by UE 500 may not have reached all UEs in the location context of the UE 502, such as the UEs in the cell #2, for example. It may also be that the UEs in the cell #2 have reached the information sent by the UE 500, but decided not to respect the license as the license at that point may have been for the location context of the UE 500, which location context does not include the UEs in the cell #2, for example. When this is the case, then the surrounding UEs in the location context of the UE 502 will know to back-off from the licensed resources after having obtained the license information from the UE 502, for example.

The delegation may allow for trading, selling or surrendering the assigned valid license locally, for example, to a highest bidder or to a new device in the location context. In addition, the delegation may not be complete delegation, but the original holder, such as the UE 500, may decide to share the resource with at least one other UE 502. This may be possible if the power levels of the UEs sharing the license are such that they do not interfere with another or the UEs are communicating with different central nodes in different directions, for example. Such a delegation system may be accompanied with a payment system, where the UE 502 who receives the delegated valid license is ready to pay for the valid license. The payment may be made to the bandwidth broker, either directly or via the UE 500.

The license may be delegated only for a temporary usage, for period of usage, or for certain time period. The license may be either requested back or it is automatically returned back to the original owner. This may be defined in the delegation parameters. Further, there may be restrictions for this delegation process, such as how many hops are allowed, how long time the delegated license is valid, how much of the license is delegated (part of the license or whole of the license), for example.

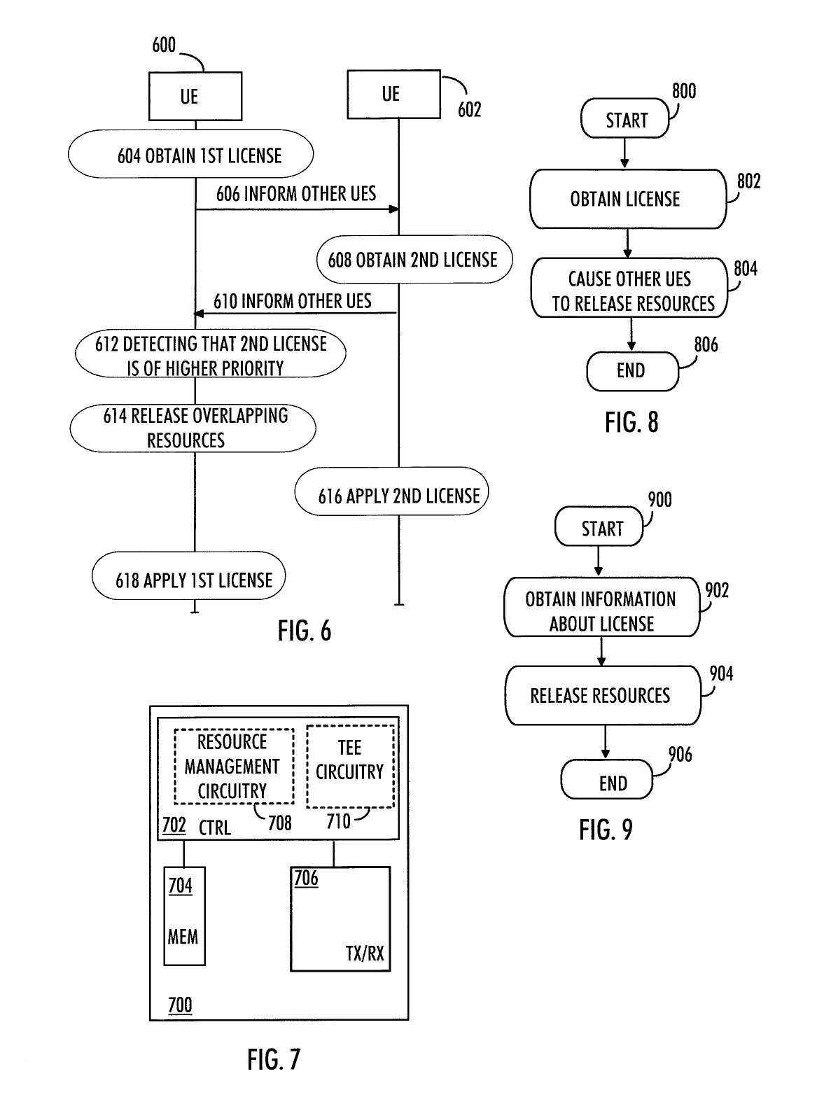

In one embodiment, as shown in FIG. 6, the license is given a priority classification. In FIG. 6, UE 600 is assumed to have obtained a first license in step 604, wherein the first license assigned to the UE 600 is accompanied with a priority identifier. The priority identifier indicates for example low priority, a high priority or a medium priority. By applying such priority identifier, different licenses may be prioritized on the spot. For example, business travelers with high-priority (wide physical range, for example) licenses may take priority over lower-cost licenses. Further criteria for prioritizing may include at least one of the following: time, location, frequency, and data type. For example, when a user with a license of short time duration is in the location context, the license may be of high priority as the UE having the license need not utilize the resources for a long time. If a user (a license holder) has been inactive and the other one (with certain priority) has been active, then activity state together with priority may become a decision factor for the current usage of the licenses. In one embodiment, the priority class may be connected to the available battery level. In this case a lower battery device may be authorized for the short period. A device with low power consumption may postpone its requests for the license usage for more convenient time, such as when more power is available, or the surrounding situation with respect to resource usage is better. Postponing may, for example, increase the priority level.

After obtaining the license in step 604, the UE 600 informs others of the assigned license in step 606. Meanwhile a UE 602 is assumed to have received a second license for its own use in step 608 with overlapping radio resources with the first license. The second license is assumed to have a higher priority identifier than the license assigned to the UE 600. The UE 602 informs others of this second license in step 610. As a result, the UE 600 obtains, in step 612, information about the second license with a higher priority identifier than the priority identifier of the license assigned to the UE 600, wherein the second license is assigned to another terminal device 602 and comprises overlapping radio resources with the license of the lower priority identifier. As a result, the UE 600 having the license with the lower priority identifier may in step 614 be caused to release the overlapping radio resources. In other words, the license holder 600 may be required to back-off when a “stronger license” appears in the local context. That is, by adding attributes to the licenses beyond ID, time, frequency and place, it is enabled that the licenses have relative priority classification. A license with high priority may cover large segments of area, for example. With these kinds of features, licenses can differentiate and mirror real-world business cases better. As a result of this type of prioritizing and backing-off, the UE 602 may apply its valid 2^{nd} license in step 616 with minimum interference and optimum throughput. The UE 600 may apply its own first license in step 618 once the second license of the UE 602 is expired, for example. Alternatively or in addition to the UE 600 may apply the radio resources in its own first license which resources do not overlap with the resources of the second valid license. In this case the use of the licenses may take place simultaneously, for example.

An embodiment, as shown in FIG. 7, provides an apparatus 700 comprising at least one processor (CTRL) 702 and at least one memory 704 including a computer program code, wherein the at least one memory 704 and the computer program code are configured, with the at least one processor 702, to cause the apparatus 700 to carry out any one of the embodiments related to functions of a terminal device. It should be noted that FIG. 7 shows only the elements and functional entities required for understanding the apparatus 700. Other components have been omitted for reasons of simplicity. The implementation of the elements and functional entities may vary from that shown in FIG. 7. The connections shown in FIG. 7 are logical connections, and the actual physical connections may be different. The connections can be direct or indirect and there can merely be a functional relationship between components. It is apparent to a person skilled in the art that the apparatus may also comprise other functions and structures.

The apparatus 700 may comprise the terminal device of a communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 700 may be or comprise a module (to be attached to the terminal device), such as a plug-in unit, an “USB dongle”, or any other kind of unit. The unit may be installed either inside the terminal device or attached to the UE with a connector or even wirelessly.

As said, the apparatus 700 may comprise the at least one processor 702. The at least one processor 702 may be implemented with a separate digital signal processor provided with suitable software embedded on a computer readable medium, or with a separate logic circuit, such as an application specific integrated circuit (ASIC). The at least one processor 702 may comprise an interface, such as computer port, for providing communication capabilities.

The at least one processor 702 may also comprise a resource management circuitry 708 for handling resource management. The circuitry 708 may cause the terminal device to transmit/receive data with certain bandwidth or frequency, to release resources, to apply different resources, for example.

The at least one processor 702 may comprise a trusted execution environment (TEE) circuitry 710. The TEE circuitry 710 may be authorized to control the cognitive radio behavior. The TEE circuitry 710 may be preconfigured with a trust root for licenses. The integrity of the trust root is guaranteed. The TEE circuitry 702 may add a cryptographic proof of the identity of the terminal and validity of the license. In this way, the other terminal devices in the location context will know that the information on the license is valid and needs to be taken into account by backing-off from the radio resources disclosed in the valid license. The TEE circuitry 710 thus actively participates in the self-governing enforcement for bandwidth use. This is enabled as the TEE circuitry 710 obtains as input the licenses from the bandwidth broker or another terminal device (delegation), for example. TEE circuitry 710 is thus able to recognize the radio resource allocation/reservation for the terminal device and trustworthy cause the other terminal devices to be informed about the valid license. The TEE circuitry 710 may have a cryptographic channel by which the TEE circuitry 710 may instruct the radio hardware to enforce the valid license and cause transmission of license related data to other terminal devices. In addition, the TEE circuitry 710 may be ensured to unconditionally obtain knowledge from the radio hardware whenever other devices are present or enter the location context. The TEE circuitry 710 may also obtain knowledge of the licenses of the other terminal devices, if they have a license. Alternatively, according to another embodiment, the apparatus 700 does not comprise such TEE circuitry 710 but is securely connected to such trusted execution environment which may mandate the CR radio behavior. The TEE circuitry 710 may decide whether a request of a license assigned to another apparatus is in order and cause the request to take place.

The apparatus 700 may further comprise radio interface components (TX/RX) 706 providing the apparatus with radio communication capabilities with the radio access network. The radio interface components 706 may comprise standard well-known components such as amplifier, filter, frequency-converter, (de)modulator, and encoder/decoder circuitries and one or more antennas. The radio interface components 706 may be responsible for broadcasting information to the other UEs, or transmitting user data to central nodes, for example. The radio interface components 706 may be responsible of receiving data from a central network unit or from a terminal device, for example.

As said, the apparatus 700 may comprise a memory 704 connected to the processor 702. However, memory may also be integrated to the processor 702 and, thus, no memory 704 may be required. The memory may be for storing data related to the licenses (own or other terminal device's), information about other terminal devices, priority information, security information such as knowledge of digital signatures or beacons, etc.

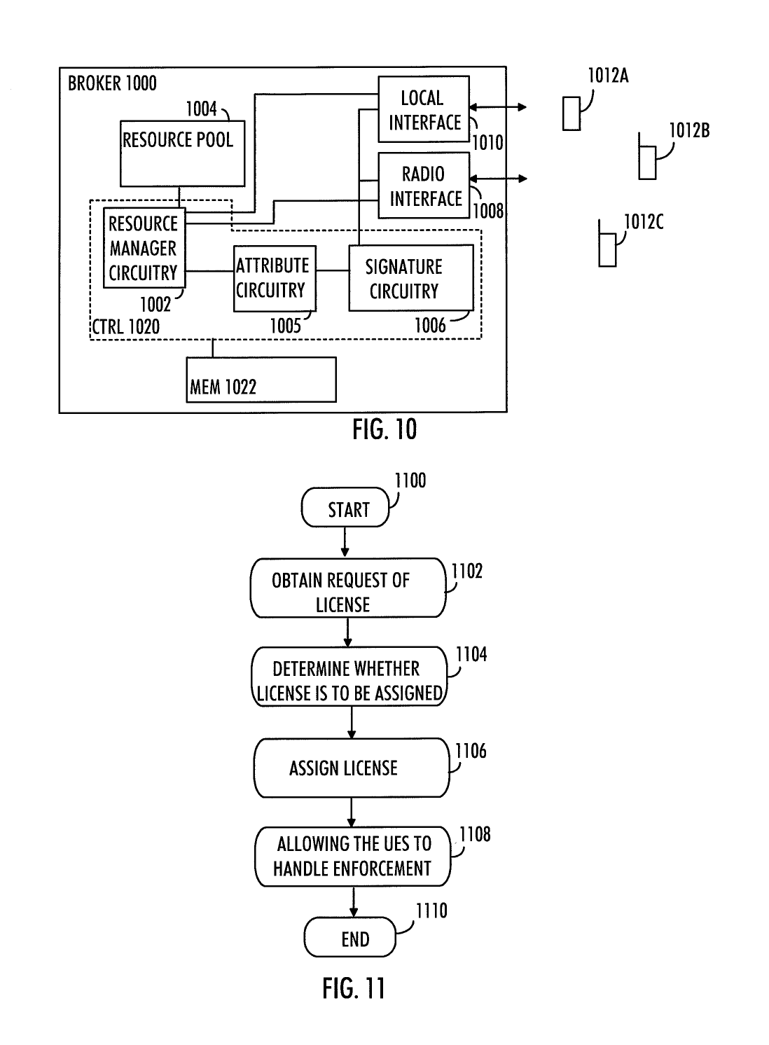

FIG. 10 shows an apparatus 1000, such as the license broker 104 of FIG. 1, for example. However, the apparatus may be any apparatus capable of handling the license assignment or plurality of license assignments. The license may relate to radio resources. It should be noted that FIG. 10 shows only the elements and functional entities required for understanding the apparatus 1000. Other components have been omitted for reasons of simplicity. The implementation of the elements and functional entities may vary from that shown in FIG. 10. The connections shown in FIG. 10 are logical connections, and the actual physical connections may be different. The connections can be direct or indirect and there can merely be a functional relationship between components. It is apparent to a person skilled in the art that the apparatus may also comprise other functions and structures.

The broker 1000 may comprise a resource manager circuitry 1002 which may be responsible of assigning resources to at least one terminal device. Whether to assign resources or not, may depend on the request of the at least one terminal device, for example. The resource manager circuitry 1002 may be aware of the resource usage in the location context or in many location contexts. The resource manager circuitry 1002 may be connected to a resource pool 1004 which may be used in selecting appropriate, available resources according to the request, for example. An attribute circuitry 1005 may be used to attach attributes, such as special features and validity restrictions to the license that is to be assigned. The attribute circuitry 1005 may, for example, specify that the license is valid over a predefined time in a predefined location context, it may specify that the license is accompanied with special “coupon”-like features, such as the ones described earlier. A signature circuitry 1006 may be used to attach a cryptographic signature or proof of validity to the license. A radio interface 1008 may be applied in transmitting the license to at least one UE 1012A, 1012B and 1012C, for example. Therefore, the broker 1000 may communicate with the at least one UE 1012A to 1012C via the radio interface. The broker 100 may also be equipped with a local interface 1010, such as a point-to-point interface, which allows the broker to communicate locally with the at least one user terminal 1012A to 1012C. An example interface may be a NFC circuitry or a Bluetooth circuitry. This may allow the broker 1000 to receive license requests in an alternative manner, for example, and may provide flexibility in the operation of the broker 1000. The license requests obtained may be, for example, more detailed, such as they may specify a certain location for the desired validity of the license. The requests from the UEs may be received by the radio interface 1008 and/or by the local interface 1010. The requests may be forwarded to the radio resource manager 1002 which may decide whether the request is accepted or not.

The apparatus 1000 may also comprise at least one processor (CTRL) 1020 for controlling the operations in the apparatus 1000. The at least one processor 1020 may be implemented with a separate digital signal processor provided with suitable software embedded on a computer readable medium, or with a separate logic circuit, such as an application specific integrated circuit (ASIC). The at least one processor 1020 may comprise an interface, such as computer port, for providing communication capabilities.

The apparatus 1000 may comprise a memory 1022 connected to the processor 1020. However, memory may also be integrated to the processor 1020 and, thus, no memory 1022 may be required. The memory may be for storing data related to the licenses, information about other terminal devices, priority information, security information such as knowledge of digital signatures or beacons, the resource pool 1004 may be stored in the memory, etc.

Therefore, in one embodiment, the apparatus 1000 comprises at least one processor (CTRL) 1020 and at least one memory 1022 including a computer program code, wherein the at least one memory 1022 and the computer program code are configured, with the at least one processor 1020 to cause the apparatus 1000 to carry out any one of the embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

FIG. 8 shows an example method of managing radio resources according to one embodiment. The method starts in step 800. In step 802, a license for specific radio resources assigned to a terminal device is obtained, wherein the license is valid at a predetermined location context for predetermined time duration. In step 804 the method comprises causing at least one surrounding terminal device in the location context to be informed about the license in order to allow the at least one surrounding terminals device to release the specific radio resources according to the license. The UE may then suspend the resource usage until the license is removed or the license is expired, for example. The method ends in step 806.

FIG. 9 shows an example method of managing radio resources according to one embodiment. The method starts in step 900. In step 902, the method comprises obtaining information of a license for specific radio resources assigned to at least one terminal device, wherein the license is valid at a predetermined location context for predetermined time duration. In step 904, the method comprises releasing the specific radio resources according to the license in order to allow the at least one terminal device to utilize the specific radio resources. The method ends in step 906.

FIG. 11 shows an example method of managing radio resources according to one embodiment. The method starts in step 1100. In step 1102, the method comprises obtaining a request of a license for specific radio resources from at least one terminal device. In step 1104, it is determined whether the license is to be assigned to the at least one terminal device or not, wherein the license is valid at a predetermined location context for a predetermined time duration. The determination result may depend on various factors, such as the urgency of the request, the battery level of the requester, the available resources with respect to the request, etc. In step 1106, the license is assigned to the at least one terminal device when the determination indicates that the license is to be assigned. It may also be that the license is assigned to a group of at least two terminal devices. In step 1108, the method comprises causing a transmission of the license to at least one terminal device, wherein the at least one terminal device is allowed to inform at least one surrounding terminal device in the location context about the license in order to allow the at least one surrounding terminal device to release the specific radio resources according to the license. When the license is assigned to a group of terminal devices, the step 1108 may comprises causing a transmission of the license to the group of at least two terminal devices. This way the UEs may be allowed to handle the enforcement of the license. The method ends in step 1110.

Some embodiments of the invention offer advantages. The following shows a few advantages as examples. For example, the embodiments provide an infrastructure for device-centric resource licensing as opposed to prior art systems which deal with cell-based licenses. The embodiments may allow a licensing structure where one may acquire radio resource licenses in advance and then notify others around about the granted license upon which one is granted a valid amount of radio resources. Therefore, the embodiments may also introduce a license validation mechanism to at least one device to verify the license notifications from surrounding devices. The device centric system allows for more dynamic and more efficient radio resource usage, for example. It may also allow managing and enforcing licenses in the absence of a centrally coordinated cognitive radio network. As the cognitive radio network inherently need not be a cellular based (base-station controlled) network, traditional mechanisms of channel reservations (base station filtering) do not necessarily apply. Such collaborative license enforcement behavior may also make it possible to trade and bargain with licenses on the spot. Thus, the embodiments may allow a system by which frequency owners can monetize their investment. Even though the embodiments have been described by using the cognitive radio as an example, the embodiments are not bound to the cognitive radio, the licensing mechanism and enforcement that is presented applies to any loosely connected network structures, like e.g. “internet of things” concepts.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configured to carry out embodiments of any of the FIGS. 1 to 11. In an embodiment, the at least one processor 702, the memory 704, and the computer program code form an embodiment of processing means for carrying out any of the embodiments related to functions of a terminal device. In an embodiment, the at least one processor 1020, the memory 1022, and the computer program code form an embodiment of processing means for carrying out any of the embodiments related to functions of an entity assigning licenses.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-30. (canceled)

31. A method, comprising:
obtaining a license for specific radio resources assigned to a terminal device, wherein the license is valid at a predetermined location context for a predetermined time duration; and
causing at least one surrounding terminal device in the location context to be informed about the license in order to allow the at least one surrounding terminal device to release the specific radio resources according to the license.

32. The method of claim 31, further comprising:
obtaining the license for specific radio resources, wherein the license is assigned to a group of at least two terminal devices.

33. The method of claim 31, further comprising:
causing at least one of the at least one surrounding terminal device to be directly informed about the license via a dedicated broadcast channel.

34. The method of claim 31, further comprising:
causing a representative of a centralized control to be informed about the license.

35. The method of claim 31, further comprising:
estimating location contexts the terminal device traverses in the future;
acquiring location context-specific licenses for the future location contexts based on the estimated future location context.

36. The method of claim 31, further comprising:
causing at least one of the at least one surrounding terminal device to be informed about the proof of identity of the terminal device to which the license has been assigned to, wherein the proof of identity is valid over the predetermined time duration.

37. The method of claim 31, further comprising:
delegating the license to at least one other terminal device in order to allow the at least one other terminal device to utilize the radio resources according to the license, wherein the delegation is accompanied with a proof that the terminal device has delegated the license.

38. The method of claim 31, wherein the license assigned to the terminal device is accompanied with a priority identifier; and the method further comprises:
obtaining information about a second license with a higher priority identifier than the priority identifier of the license assigned to the terminal device, wherein the second license is assigned to another terminal device and comprises overlapping radio resources with the license of the lower priority identifier; and
causing the terminal device having the license with the lower priority identifier to release the overlapping radio resources.

39. An apparatus, comprising:
at least one processor and at least one memory including a computer program code, wherein the at least one memory and the computer program code are configured to, with the at least one processor, cause the apparatus at least to:
obtain a license for specific radio resources assigned to a terminal device, wherein the license is valid at a predetermined location context for a predetermined time duration; and
cause at least one surrounding terminal device in the location context to be informed about the license in order to allow the at least one surrounding terminal device to release the specific radio resources according to the license.

40. The apparatus of claim 39, wherein the apparatus is further caused to:
obtain the license for specific radio resources, wherein the license is assigned to a group of at least two terminal devices.

41. The apparatus of claim 39, wherein the apparatus is further caused to:
cause at least one of the at least one surrounding terminal device to be directly informed about the license via a dedicated broadcast channel.

42. The apparatus of claim 39, wherein the apparatus is further caused to:
cause a representative of a centralized control to be informed about the license.

43. The apparatus of claim 39, wherein the apparatus is further caused to:
estimate location contexts the terminal device traverses in the future;
acquire location context-specific licenses for the future location contexts based on the estimated future location context.

44. The apparatus of claim 39, wherein the apparatus is further caused to:
cause at least one of the at least one surrounding terminal device to be informed about the proof of identity of the terminal device to which the license has been assigned to, wherein the proof of identity is valid over the predetermined time duration.

45. The apparatus of claim 39, wherein the apparatus is further caused to:
delegate the license to at least one other terminal device in order to allow the at least one other terminal device to utilize the radio resources according to the license, wherein the delegation is accompanied with a proof that the terminal device has delegated the license.

46. The apparatus of claim 39, wherein the license assigned to the terminal device is accompanied with a priority identifier, and the apparatus is further caused to:
obtain information about a second license with a higher priority identifier than the priority identifier of the license assigned to the terminal device, wherein the second license is assigned to another terminal device and comprises overlapping radio resources with the license of the lower priority identifier; and
cause the terminal device having the license with the lower priority identifier to release the overlapping radio resources.

47. An apparatus, comprising:
at least one processor and at least one memory including a computer program code, wherein the at least one memory and the computer program code are configured to, with the at least one processor, cause the apparatus at least to:
obtain information of a license for specific radio resources assigned to at least one terminal device, wherein the license is valid at a predetermined location context for a pre-determined time duration;
release the specific radio resources according to the license in order to allow the at least one terminal device to utilize the specific radio resources.

48. The apparatus of claim 47, wherein the apparatus is further caused to:
obtain the information about the license via a dedicated broadcast channel.

49. The apparatus of claim 47, wherein the apparatus is further caused to:
request the license from the at least one terminal device to which the license has been assigned to; and
obtain the license from the at least one terminal device in order for the requester to utilize the radio resources according to the license, wherein the obtained license is accompanied with a proof that the at least one terminal device to which the license has been assigned to has delegated the license to the requester.
